(19) United States
(12) Patent Application Publication
(10) Pub. No.: US 2013/0135451 A1
(43) Pub. Date: May 30, 2013

(54) Stereoscopic Image Displaying Apparatus and Corresponding Stereoscopic Image Displaying Method

(71) Applicant: Hung-Lung Hou, Shenzhen City (CN)

(72) Inventor: Hung-Lung Hou, Shenzhen City (CN)

(73) Assignee: Shenzhen China Star Optoelectronics Technology Co., LTD., Shenzhen City, Guangdong (CN)

(21) Appl. No.: 13/380,904

(22) PCT Filed: Dec. 5, 2011
(86) PCT No.: PCT/CN2011/083460

§ 371 Date: Dec. 26, 2011

(30) Foreign Application Priority Data
Nov. 24, 2011 (CN) 201110378724.6

(51) Int. Cl. H04N 13/04; G09G 3/36

(52) U.S. Cl. 348/54; 348/E13.075; 348/E13.036; 348/E13.053

(57) ABSTRACT

A stereoscopic image displaying apparatus and a corresponding stereoscopic image displaying method are disclosed. The stereoscopic image displaying apparatus comprises a display panel, a backlight module and a pair of shutter glasses. The display panel is configured to write left-eye image data and right-eye image data according to a timing sequence. The backlight module has a plurality of light source regions, and the light source regions are turned on and off according to a timing sequence to scan the left-eye image data and the right-eye image data. A left-eye shutter and a right-eye shutter of the pair of shutter glasses are turned on and off alternately to receive the left-eye image data when the left-eye shutter is turned on and to receive the right-eye image data when the right-eye shutter is turned on. When data of one image frame are to be written into the display panel, first-type scanning lines of scanning lines are enabled sequentially according to a timing sequence to write first-type image data, and then second-type scanning lines of the scanning lines are enabled sequentially according to a timing sequence to write second-type image data.

### FIELD OF THE INVENTION

The present disclosure relates to a stereoscopic image displaying apparatus and a corresponding stereoscopic image displaying method.

### BACKGROUND OF THE INVENTION

With development of science and technologies, stereoscopic (or three-dimensional (3D)) image displaying apparatuses that allow users to see realistic images have gained great popularity from the users. The stereoscopic image displaying apparatuses currently available are mainly categorized into the eyeglasses type and the non-eyeglasses type. Stereoscopic image displaying apparatuses of the eyeglasses type mainly operate in the following way: a left-eye image and a right-eye image are displayed respectively on a display panel, and then a pair of shutter glasses is used to receive the left-eye image and the right-eye image respectively so as to accomplish displaying of a stereoscopic image. On the other hand, in stereoscopic image displaying apparatuses of the non-eyeglasses type, usually an optical sheet such as a parallex barrier is disposed on a display panel to separate a left parallex image and a right parallex image from each other.

FIG. 1 is a schematic view illustrating the operational principle of a conventional stereoscopic image displaying apparatus of the eyeglasses type. As shown in FIG. 1, scanning lines on a display panel of the conventional stereoscopic image displaying apparatus of the eyeglasses type are enabled sequentially within a frame period to write left-eye image data 111 into the display panel according to a timing sequence; and then a plurality of light source regions 121˜128 in a backlight module are turned on sequentially to scan the left-eye image data 111 on the display panel region by region. At this point, a left-eye shutter of a pair of shutter glasses is turned on to receive the left-eye image data 111. Within a next frame period, the scanning lines on the display panel are enabled sequentially to write right-eye image data 112 into the display panel according to a timing sequence; and then the plurality of light source regions 121˜126 in the backlight module are turned on sequentially to scan the right-eye image data 112 on the display panel region by region. At this time point, a right-eye shutter of the pair of shutter glasses is turned on to receive the right-eye image data 112.

Therefore, under ideal conditions, one frame period will be averagely apportioned among the light source regions 121˜126 of the backlight module, and a time duration from twisting of liquid crystal molecules to turning on of the corresponding light source region will be the same for each of the regions on the display panel that correspond to the light source regions 121˜126.

However, because a response time is also needed for turning on the shutters of the pair of shutter glasses in practical applications, the response time of the shutter glasses shall also be taken into consideration. This reduces the turn-on time of the light source regions 121˜126, and makes the time duration from twisting of liquid crystal molecules to turning on of the corresponding light source region no longer the same for each of the regions on the display panel that correspond to the light source regions 121˜126. Particularly, the time duration from twisting of the liquid crystal molecules in the first region to turning on of the light source region 121 corresponding to the first region becomes longer than time durations of other regions. Consequently, liquid crystal molecules in different regions will twist to a different level, which leads to differences in luminance of the regions and also leads to uneven crosstalk.

A conventional solution to this problem is to double a frame rate (i.e., the frame frequency) at which one image frame is written into the display panel (e.g., from 120 Hz to 240 Hz) so that the time duration from twisting of the liquid crystal molecules to turning on of the corresponding light source region remains the same for each of the regions in the display panel. However, this solution has adverse effects. For example, this solution increases the frequency of the clock signal Clk, the bandwidth and the cost; and furthermore, because the charging time is shortened, difficulty in the design is increased.

Accordingly, an urgent need exists in the art to provide a novel stereoscopic image displaying apparatus and a corresponding stereoscopic image displaying method that can solve the aforesaid problem.

### SUMMARY OF THE INVENTION

An objective of the present disclosure is to provide a stereoscopic image displaying apparatus and a corresponding stereoscopic image displaying method that can solve the aforesaid problem.

To achieve the aforesaid objective, the present disclosure provides a stereoscopic image displaying apparatus, which comprises a display panel, a backlight module and a pair of shutter glasses. The display panel has a plurality of scanning lines, the scanning lines are divided into first-type scanning lines and second-type scanning lines, and left-eye image data and right-eye image data are written into the display panel according to a timing sequence. The backlight module has a plurality of light source regions, and the light source regions are turned on and off according to a timing sequence to scan the left-eye image data and the right-eye image data. A left-eye shutter and a right-eye shutter of the pair of shutter glasses are turned on and off alternately to receive the left-eye image data when the left-eye shutter is turned on and to receive the right-eye image data when the right-eye shutter is turned on. When the left-eye image data is to be written into the display panel, the first-type scanning lines among the scanning lines are enabled sequentially according to a timing sequence to write left-eye first-type image data, and then the second-type scanning lines among the scanning lines are enabled sequentially according to a timing sequence to write left-eye second-type image data. When the right-eye image data is to be written into the display panel, the first-type scanning lines among the scanning lines are enabled sequentially according to a timing sequence to write right-eye first-type image data, and then the second-type scanning lines among the scanning lines are enabled sequentially according to a timing sequence to write right-eye second-type image data.

The present disclosure further provides a stereoscopic image displaying method for use in a stereoscopic image displaying apparatus. The stereoscopic image displaying apparatus comprises a display panel, a backlight module and a pair of shutter glasses. The display panel has a plurality of scanning lines, the scanning lines are divided into first-type scanning lines and second-type scanning lines, and left-eye image data and right-eye image data are written into the display panel according to a timing sequence. The backlight module has a plurality of light source regions, and the light source regions are turned on and off according to a timing sequence to scan the left-eye image data and the right-eye image data. A left-eye shutter and a right-eye shutter of the pair of shutter glasses are turned on and off alternately to receive the left-eye image data when the left-eye shutter is turned on and to receive the right-eye image data when the right-eye shutter is turned on. The stereoscopic image displaying method comprises the following steps: turning on the first-type scanning lines sequentially according to a timing sequence to write left-eye first-type image data into the display panel; turning on the second-type scanning lines sequentially according to a timing sequence to write left-eye second-type image data to the display panel, so as to complete writing of the left-eye image data into the display panel; turning on the first-type scanning lines sequentially according to a timing sequence to write right-eye first-type image data into the display panel; and turning on the second-type scanning lines sequentially according to a timing sequence to write right-eye second-type image data into the display panel, so as to complete writing of the right-eye image data into the display panel.

Preferably, the first-type scanning lines are odd scanning lines and the second-type scanning lines are even scanning lines. Alternatively, the first-type scanning lines are even scanning lines and the second-type scanning lines are odd scanning lines.

Preferably, the stereoscopic image displaying apparatus further comprises a display panel drive circuit, a backlight module drive circuit, a shutter glasses drive circuit and a controller. The display panel drive circuit is configured to write image data to the display panel; the backlight module drive circuit is configured to turn on and off the light source regions in the backlight module according to a timing sequence; the shutter glasses drive circuit is configured to turn on and off the left-eye shutter and the right-eye shutter alternately; and the controller is configured to control the display panel drive circuit, the backlight module drive circuit and the shutter glasses drive circuit respectively.

Preferably, the display panel is a liquid crystal display (LCD) panel.

According to the above descriptions, the image data written within one frame period is divided into two sections: one section is the odd image data and the other section is the even image data. In this way, the number of scanning lines to be enabled sequentially every time when image data is written into the display panel is reduced by a half, and the time required is also reduced by a half to result in a high speed comparable to that obtained by doubling the frame frequency in the prior art. This can make the time duration from twisting of liquid crystal molecules to turning on of the corresponding light source region the same for each of the displaying regions, thus improving the uniformity of crosstalk. Furthermore, as the time taken to input data of one image frame completely remains the same as the time taken in the prior art, it is unnecessary to increase the frame frequency and, consequently, no adverse effect associated with increasing the frame frequency will be caused.

What described above is only a summary of the present disclosure. In order to provide a better understanding of the technical solutions of the present disclosure so that the present disclosure can be practiced according to disclosures of this specification and in order to make the aforesaid and other objectives, features and advantages of the present disclosure more apparent, preferred embodiments of the present disclosure will be described hereinafter with reference to the attached drawings.

### BRIEF DESCRIPTION OF THE DRAWINGS

FIG. 1 is a schematic view illustrating the operational principle of a conventional stereoscopic image displaying apparatus of the eyeglasses type;

FIG. 2 is a schematic view of a stereoscopic image displaying apparatus according to a preferred embodiment of the present disclosure;

FIG. 3 is a schematic view of a display panel shown in FIG. 2; and

FIG. 4 is a schematic view illustrating the operational principle of the stereoscopic image displaying apparatus shown in FIG. 2.

### DETAILED DESCRIPTION OF THE INVENTION

Various embodiments of the disclosure are now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

In order to further describe the technical solutions adopted to achieve the objectives of the present disclosure and the efficacies thereof, implementations, methods, steps, structures, features and efficacies of the color flat display panel and the corresponding color flat display device according to the present disclosure will be detailed hereinbelow with reference to the attached drawings and preferred embodiments thereof. The aforesaid and other technical disclosures, features and efficacies of the present disclosure will become apparent from the following detailed description of the preferred embodiments that is made with reference to the attached drawings. The technical solutions and the efficacies thereof will be better understood by those of ordinary skill in the art upon reviewing the following description. However, the attached drawings are only provided for illustration purpose but not to limit the present disclosure.

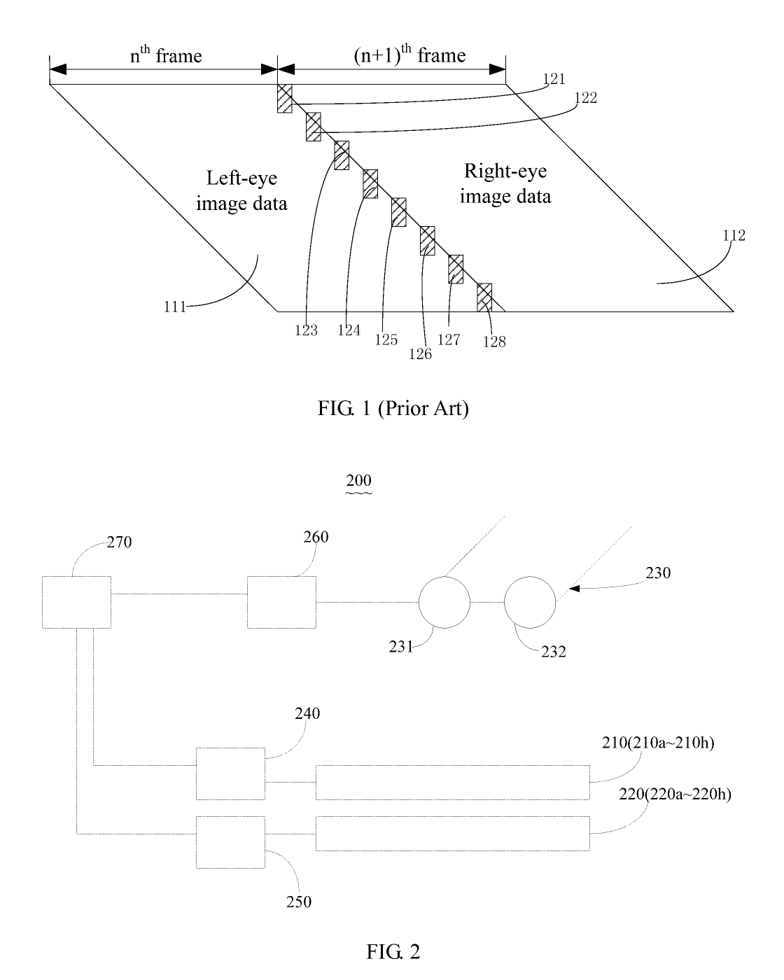

FIG. 2 is a schematic view of a stereoscopic image displaying apparatus according to a preferred embodiment of the present disclosure. As shown in FIG. 2, the stereoscopic image displaying apparatus 200 of the present disclosure mainly comprises a display panel 210, a backlight module 220 and a pair of shutter glasses 230.

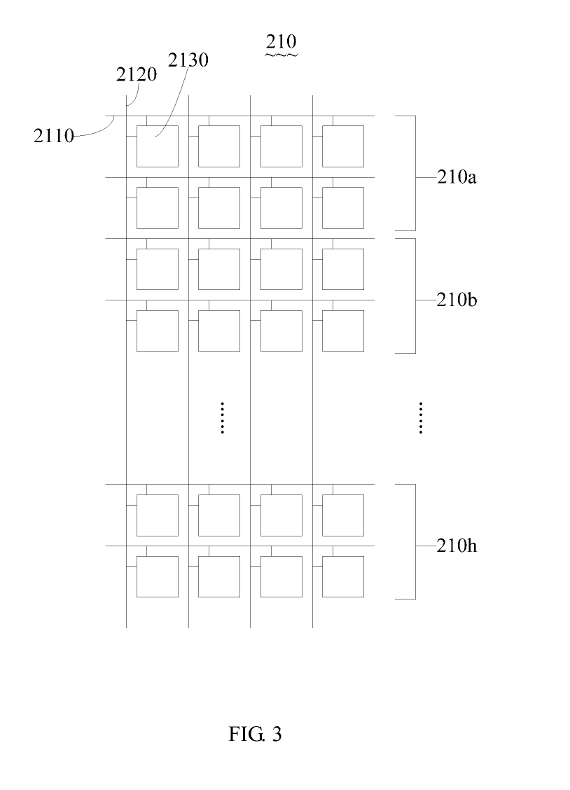

The display panel 210 may be an LCD panel, and left-eye image data and right-eye image data are written into the display panel 210 according to a timing sequence. FIG. 3 is a schematic view of a display panel shown in FIG. 2. As shown in FIG. 3, the display panel 210 has a plurality of scanning lines 2110, a plurality of data lines 2120 and a plurality of pixels 2130. Each of the scanning lines 2110 is electrically connected to a row of pixels 2130 in a row direction, and each of the data lines 2120 is electrically connected to a column of pixels 2130 in a column direction. Furthermore, as shown in FIG. 3, the display panel 210 may be divided into a plurality of displaying regions such as eight displaying regions 210a˜210h.

Correspondingly, the backlight module 220 may also be divided into a plurality of light source regions 220a˜220h each corresponding to one displaying region. The light source regions 220a˜220h are turned on and off according to a timing sequence to scan the left-eye image data and the right-eye image data sequentially.

A left-eye shutter 231 and a right-eye shutter 232 of the pair of shutter glasses 230 are turned on and off alternately to receive the left-eye image data when the left-eye shutter 231 is turned on and to receive the right-eye image data when the right-eye shutter 232 is turned on.

Furthermore, the stereoscopic image displaying apparatus 200 further comprises a display panel drive circuit 240, a backlight module drive circuit 250, a shutter glasses drive circuit 260 and a controller 270. The controller 270 is electrically connected with the display panel drive circuit 240, the backlight module drive circuit 250 and the shutter glasses drive circuit 260 respectively to control these drive circuits. The display panel drive circuit 240 is configured to drive the display panel 210 so as to write image data to the display panel 210, and may comprise a gate drive circuit and a source drive circuit. The backlight module drive circuit 250 is configured to drive the backlight module 220 to turn on and off the light source regions in the backlight module 220 according to a timing sequence. The shutter glasses drive circuit 260 is configured to drive the pair of shutter glasses 230 to turn on and off the left-eye shutter 231 and the right-eye shutter 232 alternately.

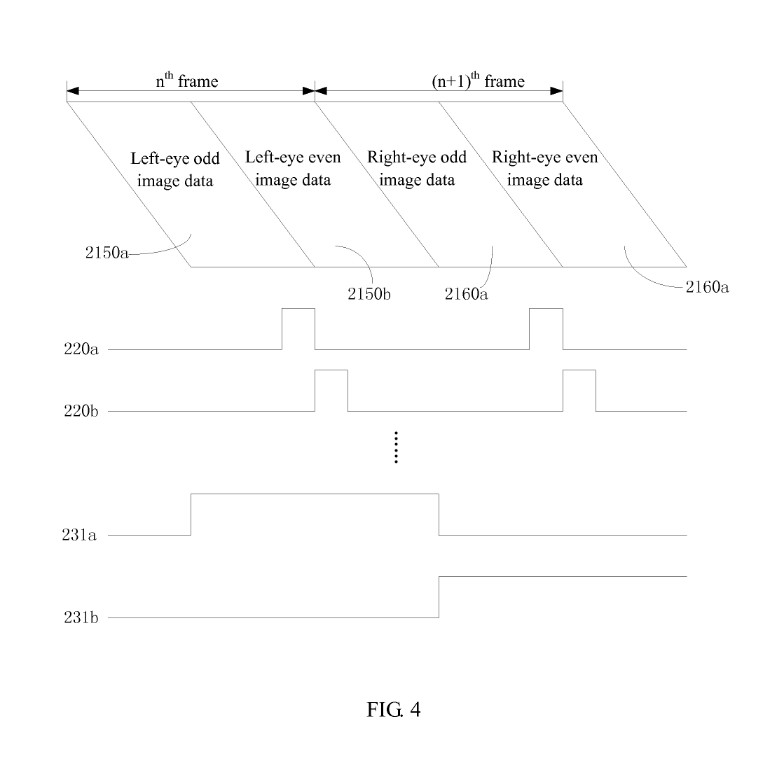

FIG. 4 is a schematic view illustrating the operational principle of the stereoscopic image displaying apparatus shown in FIG. 2. Referring to FIG. 2 to FIG. 4 together, when the left-eye image data is to be written into the display panel 210 within the n^{th} frame period, the odd scanning lines 2110 in the displaying regions 210a˜210h are enabled sequentially according to a timing sequence to write left-eye odd image data 2150a according to the timing sequence. Then, the even scanning lines 2110 in the displaying regions 210a˜210h are enabled sequentially according to a timing sequence to write left-eye even image data 2150b according to the timing sequence.

Preferably, in the present disclosure, the first light source region 220a may be turned on to scan the left-eye image data displayed in the first displaying region 210a after writing of the left-eye odd image data 2150a is completed and the even scanning lines 2110 in the first displaying region 210a are enabled sequentially (i.e., after the left-eye odd image data 2150a and the left-eye even image data 2150b are both written into the first displaying region 210a). Then, other light source regions 220b˜220h are turned on sequentially to scan the left-eye image data displayed in other displaying regions 210b˜210h region by region.

Furthermore, in the present disclosure, the left-eye shutter 231 of the pair of shutter glasses 230 may be turned on to receive the left-eye image data after writing of the left-eye odd image data 2150a is completed.

Within a next frame period (i.e., the (n+1)^{th} frame period), the right-eye image data is written in the same way as that of the left-eye image data. That is, the odd scanning lines 2110 in the displaying regions 210a˜210h are enabled sequentially according to a timing sequence to write right-eye odd image data 2160a according to the timing sequence. Then, the even scanning lines 2110 in the displaying regions 210a˜210h are enabled sequentially according to a timing sequence to write right-eye even image data 2160b according to the timing sequence.

Preferably, in the present disclosure, the first light source region 220a may be turned on to scan the right-eye image data displayed in the first displaying region 210a after writing of the right-eye odd image data 2160a is completed and the even scanning lines 2110 in the first displaying region 210a are enabled sequentially (i.e., after the right-eye odd image data 2160a and the right-eye even image data 2160b are both written into the first displaying region 210a). Then, other light source regions 220b˜220h are turned on sequentially to scan the right-eye image data displayed in other displaying regions 210b˜210h region by region.

Furthermore, in the present disclosure, the right-eye shutter 232 of the pair of shutter glasses 230 may be turned on to receive the right-eye image data after writing of the right-eye odd image data 2160a is completed.

According to the above descriptions, in the present disclosure, the image data written within one frame period is divided into two sections: one section is the odd image data and the other section is the even image data. In this way, the number of scanning lines to be enabled sequentially every time when image data is written into the display panel is reduced by a half, and the time required is also reduced by a half to result in a high speed comparable to that obtained by doubling the frame frequency in the prior art. This can make the time duration from twisting of liquid crystal molecules to turning on of the corresponding light source regions 220a˜220h the same for each of the displaying regions 210a˜210h, thus improving the uniformity of crosstalk. Furthermore, as the time taken to input data of one image frame completely remains the same as the time taken in the prior art, it is unnecessary to increase the frame frequency and, consequently, no adverse effect associated with increasing the frame frequency will be caused.

Furthermore, in the present disclosure, the image data may also be written within a frame period in the following way. That is, the even scanning lines 2110 in the displaying regions 210a˜210h of the display panel 210 are enabled sequentially to write the even image data, and then the odd scanning lines 2110 in the displaying regions 210a˜210h are enabled sequentially to write the odd image data.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A stereoscopic image displaying apparatus, comprising:
a display panel having a plurality of scanning lines, wherein the scanning lines are divided into first-type scanning lines and second-type scanning lines, left-eye image data and right-eye image data are written into the display panel according to a timing sequence, and the first-type scanning lines are odd scanning lines and the second-type scanning lines are even scanning lines;
a backlight module having a plurality of light source regions, wherein the light source regions are turned on and off according to a timing sequence to scan the left-eye image data and the right-eye image data; and
a pair of shutter glasses, a left-eye shutter and a right-eye shutter of the pair of shutter glasses are turned on and off alternately to receive the left-eye image data when the left-eye shutter is turned on and to receive the right-eye image data when the right-eye shutter is turned on;
wherein when the left-eye image data is to be written into the display panel, the first-type scanning lines among the scanning lines are enabled sequentially according to a timing sequence to write left-eye first-type image data, and then the second-type scanning lines among the scanning lines are enabled sequentially according to a timing sequence to write left-eye second-type image data; and when the right-eye image data are to be written into the display panel, the first-type scanning lines among the scanning lines are enabled sequentially according to a timing sequence to write right-eye first-type image data, and then the second-type scanning lines among the scanning lines are enabled sequentially according to a timing sequence to write right-eye second-type image data.

2. The stereoscopic image displaying apparatus of claim 1, wherein the display panel is a liquid crystal display (LCD) panel.

3. A stereoscopic image displaying apparatus, comprising:
a display panel having a plurality of scanning lines, wherein the scanning lines are divided into first-type scanning lines and second-type scanning lines, and left-eye image data and right-eye image data are written into the display panel according to a timing sequence;
a backlight module having a plurality of light source regions, wherein the light source regions are turned on and off according to a timing sequence to scan the left-eye image data and the right-eye image data; and
a pair of shutter glasses, a left-eye shutter and a right-eye shutter of the pair of shutter glasses are turned on and off alternately to receive the left-eye image data when the left-eye shutter is turned on and to receive the right-eye image data when the right-eye shutter is turned on;
wherein when the left-eye image data is to be written into the display panel, the first-type scanning lines among the scanning lines are enabled sequentially according to a timing sequence to write left-eye first-type image data, and then the second-type scanning lines among the scanning lines are enabled sequentially according to a timing sequence to write left-eye second-type image data; and when the right-eye image data is to be written into the display panel, the first-type scanning lines among the scanning lines are enabled sequentially according to a timing sequence to write right-eye first-type image data, and then the second-type scanning lines among the scanning lines are enabled sequentially according to a timing sequence to write right-eye second-type image data.

4. The stereoscopic image displaying apparatus of claim 3, wherein the first-type scanning lines are odd scanning lines and the second-type scanning lines are even scanning lines.

5. The stereoscopic image displaying apparatus of claim 3, wherein the first-type scanning lines are even scanning lines and the second-type scanning lines are old scanning lines.

6. The stereoscopic image displaying apparatus of claim 3, further comprising:
a display panel drive circuit, being configured to write image data to the display panel;
a backlight module drive circuit, being configured to turn on and off the light source regions in the backlight module according to a timing sequence;
a shutter glasses drive circuit, being configured to turn on and off the left-eye shutter and the right-eye shutter alternately; and
a controller, being configured to control the display panel drive circuit, the backlight module drive circuit and the shutter glasses drive circuit respectively.

7. The stereoscopic image displaying apparatus of claim 3, wherein the display panel is an LCD (liquid crystal display) panel.

8. A stereoscopic image displaying method for use in a stereoscopic image displaying apparatus, wherein the stereoscopic image displaying apparatus comprises a display panel, a backlight module and a pair of shutter glasses, the display panel has a plurality of scanning lines which are divided into first-type scanning lines and second-type scanning lines, left-eye image data and right-eye image data are written into the display panel according to a timing sequence, the backlight module has a plurality of light source regions, the light source regions are turned on and off sequentially according to a timing sequence to scan the left-eye image data and the right-eye image data, and a left-eye shutter and a right-eye shutter of the pair of shutter glasses are turned on and off alternately to receive the left-eye image data when the left-eye shutter is turned on and to receive the right-eye image data when the right-eye shutter is turned on, the stereoscopic image displaying method comprising:
turning on the first-type scanning lines sequentially according to a timing sequence to write left-eye first-type image data into the display panel;
turning on the second-type scanning lines sequentially according to a timing sequence to write left-eye second-type image data to the display panel, so as to complete writing of the left-eye image data into the display panel;
turning on the first-type scanning lines sequentially according to a timing sequence to write right-eye first-type image data into the display panel; and
turning on the second-type scanning lines sequentially according to a timing sequence to write right-eye second-type image data into the display panel, so as to complete writing of the right-eye image data into the display panel.

9. The stereoscopic image displaying method of claim 8, wherein the first-type scanning lines are odd scanning lines and the second-type scanning lines are even scanning lines.

10. The stereoscopic image displaying method of claim 8, wherein the first-type scanning lines are even scanning lines and the second-type scanning lines are odd scanning lines.

11. The stereoscopic image displaying method of claim 8, wherein the display panel is an LCD (liquid crystal display) panel.
